(19) United States
(12) Patent Application Publication
(10) Pub. No.: US 2009/0148609 A1
(43) Pub. Date: Jun. 11, 2009

(54) METHOD OF MANUFACTURING MAGNESIUM OXIDE NANOPARTICLES AND METHOD OF MANUFACTURING MAGNESIUM OXIDE NANOSOL

(75) Inventors: Chul Tack LIM, Suwon (KR); Byoung Jin Chun, Suwon (KR); Chang Hwan Choi, Seongnam (KR); Jin Hyuck Yang, Suwon (KR); Seung Ho Lee, Seoul (KR); Dae Sung Kim, Seoul (KR); Hyung Mi Lim, Gunpo (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO. LTD.

(21) Appl. No.: 12/244,883

(22) Filed: Oct. 3, 2008

(30) Foreign Application Priority Data
Dec. 7, 2007 (KR) 10-2007-0126799

(51) Int. Cl. B05D 3/02; B02C 19/00

(52) U.S. Cl. 427/380; 427/372.2; 241/23

(57) ABSTRACT

Disclosed are a method of manufacturing magnesium oxide nanoparticles and a method of manufacturing a magnesium oxide nanosol, which can prepare magnesium oxide particles having a size of tens of nanometers with high yield by using a simple, low-cost process. The methods of manufacturing magnesium oxide nanoparticles and manufacturing magnesium oxide nanosol include preparing a magnesium salt solution by dissolving a magnesium salt in a solvent; impregnating an organic polymer comprising a nanosized pore with the magnesium salt solution; and heating the organic polymer impregnated with the magnesium salt solution until the organic polymer is fired.

### CROSS-REFERENCE TO RELATED APPLICATIONS

This application claims the priority of Korean Patent Application No. 2007-126799 filed on Dec. 7, 2007, in the Korean Intellectual Property Office, the disclosure of which is incorporated herein by reference.

### BACKGROUND OF THE INVENTION

1. Field of the Invention

The present invention relates to a method of manufacturing magnesium oxide nanoparticles and a method of manufacturing a magnesium oxide nanosol, and more particularly, to a method of manufacturing magnesium oxide nanoparticles and a method of manufacturing a magnesium oxide nanosol, which can prepare magnesium oxide particles having a size of tens of nanometers with high yield by using a simple, low-cost process.

2. Description of the Related Art

As products are developed to have smaller sizes and slimmer profiles with higher capacity, a process of preparing fine particles of a raw material becomes more important and is considered as a core technique in a product manufacturing process.

For example, when a multilayer ceramic capacitor (MLCC) is manufactured, barium titanate (BaTiO₃) is used as a main component of a dielectric, and an additive (mainly, a metal oxide) is also used to affect chip characteristics of the MLCC. To increase electrostatic capacitance of the MLCC, not only the barium titanate but also the additive needs to be prepared as fine particles, uniformly dispersed as primary particles and stably maintain their dispersion state.

In due consideration of the fact that an average particle size of the barium titanate being widely used in a slim and high capacity MLCC is about 150 nm, an additive must have a particle size of tens of nanometers to desirably coat a surface of the barium titanate. Also, to manufacture the slim and high capacity MLCC, composition uniformity of an internal electrode and a dielectric layer must be maintained, and pore formation in the dielectric must be prevented. Thus, the main component of the dielectric and the additive must be prepared as fine particles and dispersion thereof must be stabilized.

Magnesium oxide may be used as an additive in manufacturing the MLCC. The magnesium oxide forms a shell on a powder surface to prevent grain growth of BaTiO₃ and diffusion of other additive elements into a core during a sintering process. Besides, the magnesium oxide is widely used in various technical fields, e.g., as a fluorescent coating layer or a layer protecting a plasma display panel (PDP) dielectric from sputtering by excited ions in a plasma display space.

An example of a method of manufacturing magnesium oxide includes a top-down method. In the top-down method, a magnesium oxide precursor having a primary average particle size of about 100 nm to about 200 nm is made into slurry and the slurry is ground into smaller particles by using a grinding machine. That is, the top-down method is a method in which powder having a particle size greater than a desired particle size is ground into smaller-sized particles.

If a particle size of the magnesium oxide precursor is small, particles having a size of tens of nanometers can be easily obtained, but the precursor is undesirably expensive. If a precursor with a great particle size is used, a grinding process for obtaining smaller particles is complicated. Also, even after the grinding process, the ground particles may have undesired shapes or aggregate with one another. FIG. 1 shows a field emission scanning electron microscope (FE-SEM) image of magnesium oxide manufactured by a related art method. Referring to FIG. 1, magnesium oxide particles exist aggregating with each other, and shapes and sizes thereof are not uniform.

To cope with the aforementioned limitations, an aerosol method or a method of decomposing a precursor with microwave plasma has been proposed for preparation of the magnesium oxide. However, those proposed methods have limitations in particle-size control since they are also the top-down method employing a principle of grinding powder into smaller particles.

Even if the magnesium oxide is used as an additive in smaller amount as compared to another raw material as in the MLCC, the magnesium oxide is an essential additive having a significant effect for its added amount. Thus, the magnesium oxide significantly affects the overall performance or quality of a product.

However, it is difficult to prepare magnesium oxide particles that have a desired shape and a size of tens of nanometers by using the related art method. Therefore, there is a need for a simpler process by which magnesium oxide particles having a desired size and shape can be prepared.

### SUMMARY OF THE INVENTION

An aspect of the present invention provides a method of manufacturing magnesium oxide nanoparticles and a method of manufacturing a magnesium oxide nanosol, which can prepare magnesium oxide particles having a size of tens of nanometers with high yield by using a simple, low-cost process.

According to an aspect of the present invention, there is provided a method of manufacturing magnesium oxide nanoparticles, including: preparing a magnesium salt solution by dissolving a magnesium salt in a solvent; impregnating an organic polymer including a nanosized pore with the magnesium salt solution; and heating the organic polymer impregnated with the magnesium salt solution until the organic polymer is fired.

The magnesium salt solution may be a magnesium nitrate (Mg(NO₃)₂) solution. The magnesium salt solution may have a concentration ranging from 5 wt % to 15 wt %.

When the organic polymer is impregnated with the solution containing the magnesium salt, heating may be performed to fire the organic polymer. The heating the organic polymer may be performed at a temperature ranging from 600° C. to 700° C. The heating the organic polymer may be performed for 30 minutes to 5 hours. The heating the organic polymer may be performed at a heating rate of 2° C./h to 20° C./h.

The pore of the organic polymer may have a size on a nanoscale, ranging from 1 nm to 9 nm. The magnesium oxide nanoparticles manufactured by the method of manufacturing dysprosium nanoparticles may have a size ranging from 30 nm to 60 nm.

The method may further include drying the organic polymer impregnated with the magnesium salt solution before the heating the organic polymer.

The method may further include milling a heating residue after the heating the organic polymer.

According to another aspect of the present invention, there is provided a method of manufacturing a magnesium oxide nanosol, including: preparing a magnesium salt solution by dissolving a magnesium salt in a solvent; impregnating an organic polymer including a nanosized pore with the magnesium salt solution; heating the organic polymer impregnated with the magnesium salt solution until the organic polymer is fired; milling a heating residue; and dispersing the milled heating residue in an organic solvent. The organic solvent may be ethanol.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a FE-SEM image of magnesium oxide particles prepared by a related art method;

FIG. 2 is a view showing that magnesium oxide particles are trapped within respective pores of an organic polymer according to an embodiment of the present invention;

FIG. 3 is a graph showing a result of particle-size analysis with respect to the volume of magnesium oxide nanoparticles prepared by the method of manufacturing magnesium oxide nanoparticles according to the embodiment of the present invention;

FIG. 4 is a graph showing a result of particle-size analysis with respect to the number of magnesium oxide nanoparticles identical to those of FIG. 3, prepared by the method of manufacturing magnesium oxide nanoparticles according to the embodiment of the present invention;

FIG. 5 is a graph showing XRD data of magnesium oxide nanoparticles prepared by the method of manufacturing magnesium oxide nanoparticles according to the embodiment of the present invention;

FIG. 6 is a transmission electron microscope (TEM) image of magnesium oxide nanoparticles prepared by the method of manufacturing magnesium oxide nanoparticles according to the embodiment of the present invention; and

FIG. 7 is a SEM image of magnesium oxide nanoparticles identical to those of FIG. 6.

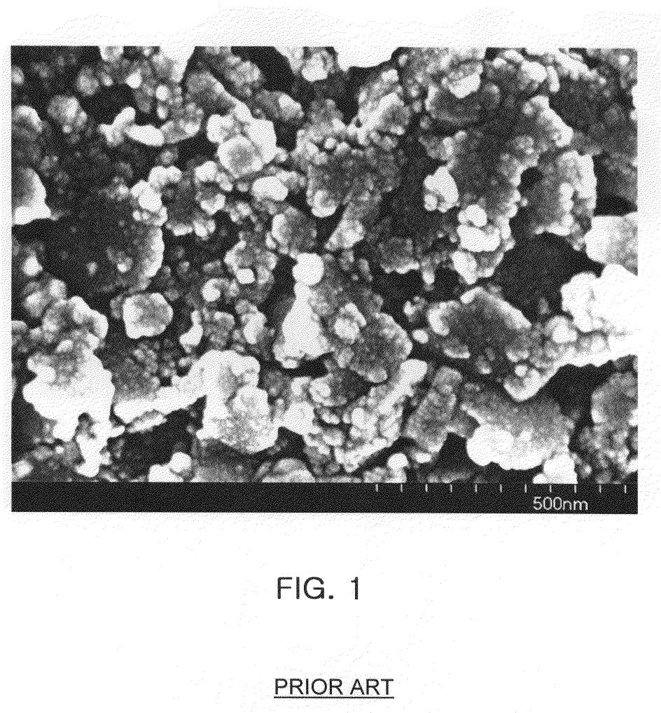

### DETAILED DESCRIPTION OF THE PREFERRED EMBODIMENT

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

A method of manufacturing magnesium oxide nanoparticles according to an embodiment of the present invention includes: preparing a magnesium salt solution by dissolving a magnesium salt in a solvent; impregnating an organic polymer including a nanosized pore with the magnesium salt solution; and heating the organic polymer impregnated with the magnesium salt solution until the organic polymer is fired.

First, to prepare magnesium oxide (MgO), a solution containing a magnesium salt (hereinafter, referred to as a magnesium salt solution) is prepared. The oxidation number of magnesium is +2, and thus the magnesium oxide is magnesium monoxide (MgO).

The magnesium salt solution used in the current embodiment of the present invention is not particularly limited. However, the magnesium salt solution must be used for impregnation of an organic polymer and the magnesium salt must be oxidized to magnesium oxide at a firing temperature of the organic polymer.

The solvent may be water or an organic solvent. When the solvent is water, the magnesium salt solution may contain nitric acid. In this case, the magnesium salt solution may be magnesium nitrate (Mg(NO₃)₂) aqueous solution. The concentration of the solution is determined in due consideration of a pore characteristic of the organic polymer to be impregnated. For example, the concentration of the magnesium nitrate solution may range from 5 wt % to 15 wt %.

If the concentration is lower than 5 wt %, the amount of magnesium salt acting as a precursor of magnesium oxide becomes insufficient, resulting in low yield of the magnesium oxide, which is an end product. If the concentration exceeds 15 wt %, a disparity between a limited number of pores of the organic polymer and the number of nanoparticles to be trapped therein may occur, undesirably resulting in aggregation of the nanoparticles.

After the magnesium salt solution is prepared, the organic polymer having nanosized pores is impregnated with the magnesium salt solution. The organic polymer may have pores of a predetermined size such as a pulp-type fiber texture. Particularly, the organic polymer usable in the embodiment of the present invention may have nanosized pores, so that particles on the nanoscale can be generated. For example, the organic polymer may be cellulose which is an organic compound in plants. The cellulose has chemical formula (C₆H₁₀O₆)ₙ, and generates carbon dioxide (CO₂) and water (H₂O) when heated.

The term ‘nanosized’ in the ‘nanosized pores’ refers to a size of a few nanometers. The magnesium salt, which is a precursor of magnesium oxide, is trapped within the nanosized pores of the organic polymer before the magnesium salt becomes the magnesium oxide. Thus, the prepared magnesium oxide has a particle size of tens of nanometers. Hence, the pore size of the organic polymer may range from 1 nm to 9 nm.

According to the current embodiment of the present invention, to prepare magnesium oxide nanoparticles, the organic polymer with the nanosized pores is impregnated with the solution containing the magnesium salt, and nanosized magnesium salt particles are trapped within the respective pores of the organic polymer.

FIG. 2 is a view showing that magnesium salt particles 200 are trapped within respective pores 110 of an organic polymer 100 according to the embodiment of the present invention. The magnesium salt particles 200 exist in the size of a few nanometers, trapped within the respective nanosized pores 110 of the organic polymer 100.

Since the magnesium salt particles 200 are respectively trapped within the pores 110 of the organic polymer 100, the magnesium salt particles 200 do not aggregate at the time of reaction. Since the precursor itself exists in the size of a few nanometers, resultant magnesium oxide particles can have the size of tens of nanometers. Also, the magnesium oxide particles can be controlled to have uniform shapes.

The magnesium oxide nanoparticles prepared by the above method of manufacturing magnesium oxide nanoparticles according to the current embodiment have a size of tens of nanometers. For example, the particle size of the magnesium oxide may range from 30 nm to 60 nm.

After the organic polymer is impregnated with the magnesium salt solution, the organic polymer is heated. As mentioned above, when heated, the organic polymer (e.g., (C₆H₁₀O₆)ₙ) generates CO₂ and H₂O. Thus, the organic polymer can be removed by heating.

The organic polymer impregnated with the magnesium salt component may be heated at a temperature ranging from 600° C. to 700° C. for 30 minutes to 5 hours. Also, the heating may be performed at a heating rate of 2° C./h to 20° C./h.

The method of manufacturing magnesium oxide nanoparticles according to the current embodiment of the present invention may further include drying the organic polymer impregnated with the magnesium salt solution before the heating of the organic polymer. If the organic polymer is impregnated with an excessive amount of magnesium salt, a magnesium crystal or salt larger than the nanoscale may be generated on a surface of the organic polymer. Therefore, the drying method or another method may be used to remove the excessive amount of magnesium salt solution.

The method of manufacturing magnesium oxide nanoparticles according to the current embodiment of the present invention may further include cooling a heating residue resulting from the heating and milling the cooled heating residue. That is, after the magnesium oxide nanoparticles of tens of nanometers are manufactured by using the organic polymer, the milling may be performed to make the magnesium oxide nanoparticles have a uniform size. After the milling operation, particle-size analysis is performed. If the particle-size analysis reveals that magnesium oxide nanoparticles having a desired size and shape are manufactured, the milling operation is stopped and the magnesium oxide nanoparticles are collected. In such a manner, uniform magnesium oxide nanoparticles with a desired size are obtained.

According to another embodiment of the present invention, a method of manufacturing a magnesium oxide nanosol includes: preparing a magnesium salt solution by dissolving a magnesium salt in a solvent; impregnating an organic polymer including a nanosized pore with the magnesium salt solution; heating the organic polymer impregnated with the magnesium salt solution until the organic polymer is fired; milling a heating residue from the heating; and dispersing the milled heating residue in an organic solvent. The organic solvent may be ethanol.

To obtain the heating residue, i.e., magnesium oxide powder, the organic polymer impregnated with the magnesium salt solution is fired by heating the organic polymer. Then, the magnesium oxide powder is milled and dispersed in a predetermined solvent, thereby preparing nanosol of uniform particles. To prepare the nanosol, ethanol may be used. If it is difficult to disperse the milled magnesium oxide particles in the predetermined solvent, a dispersant such as a surfactant is used. The surfactant may be an organic polymer-based surfactant.

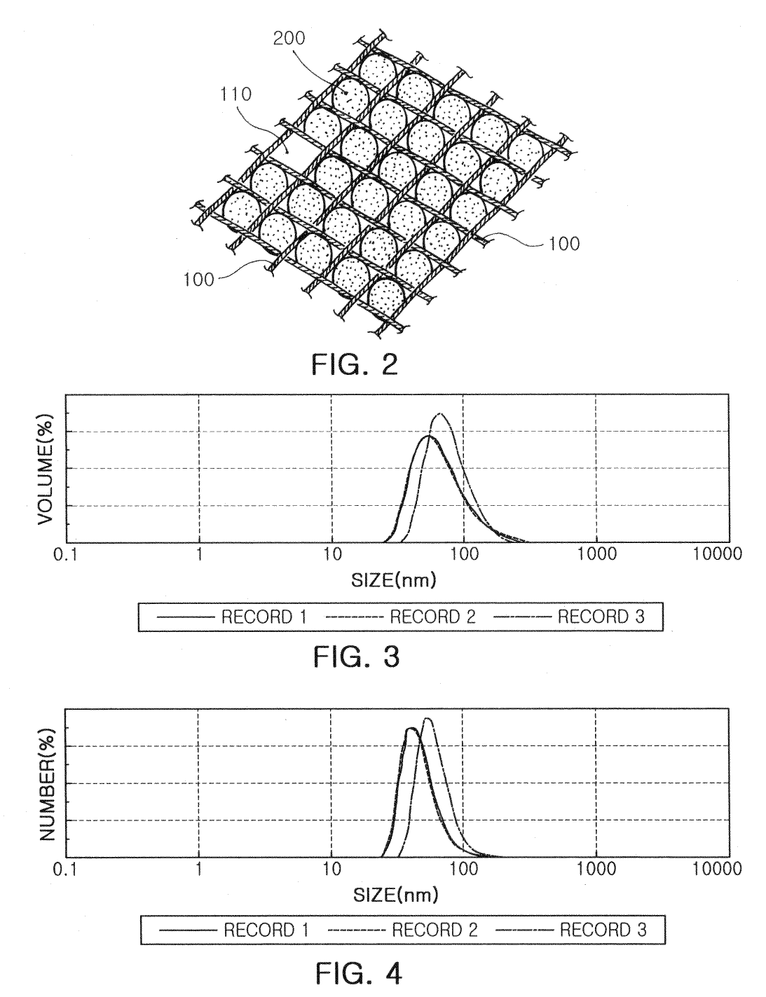

FIG. 3 is a graph showing a result of particle-size analysis with respect to the volume of magnesium oxide nanoparticles prepared by the method of preparing magnesium oxide nanoparticles according to the embodiment of the present invention. FIG. 4 is a graph showing a result of particle-size analysis with respect to the number of magnesium oxide nanoparticles identical to those of FIG. 3.

The particle-size analysis of the magnesium oxide nanoparticles is performed three times on the same magnesium oxide nanoparticles, and average particle sizes are calculated with respect to the cumulative volume and the cumulative number. The average particle sizes with respect to the cumulative volume are shown in Table 1, and the average particle sizes with respect to the cumulative number are shown in Table 2.

TABLE 1

Cumulative volume (%)

| | 10 | 50 | 90 | 99.9 |
|---|---|---|---|---|
| Record 1 | 38.4 | 60.8 | 117 | 275 |
| Record 2 | 38.1 | 60.5 | 117 | 282 |
| Record 3 | 48.6 | 72.2 | 119 | 221 |
| Average | 41.7 | 64.5 | 118 | 259 |

TABLE 2

Cumulative number
of particles (%)

| | 10 | 50 | 90 | 99.9 |
|---|---|---|---|---|
| Record 1 | 32.6 | 44.3 | 67.6 | 160 |
| Record 2 | — | 43.8 | 67.2 | 160 |
| Record 3 | 42.9 | 57.5 | 85.1 | 167 |
| Average | 37.7 | 48.5 | 73.3 | 162 |

Referring to Table 1, according to the current embodiment of the present invention, it can be seen that magnesium oxide nanoparticles corresponding to 50% of the entire volume have a size of about 60 nm. With respect to the entire number of nanoparticles, 50% of the magnesium oxide nanoparticles have a size of about 45 nm to about 50 nm. Also, it can be seen that uniform magnesium oxide nanoparticles are generated since 10% to 50% of the magnesium oxide nanoparticles with respect to the number of nanoparticles have a size of about 35 nm to about 48 nm.

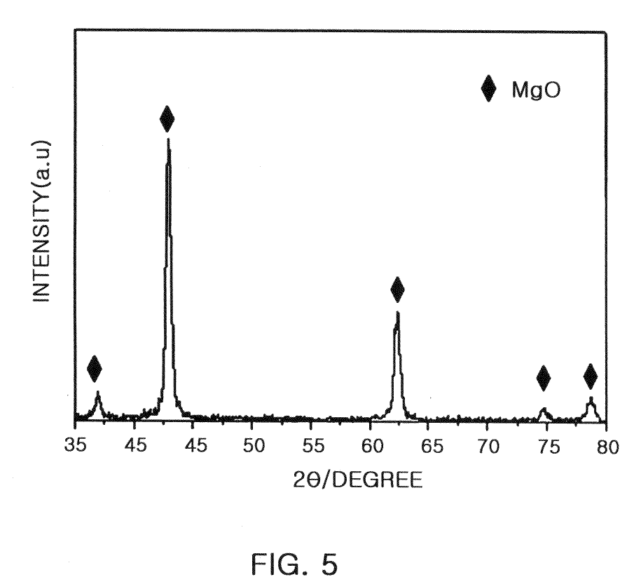

FIG. 5 is a graph showing XRD data of the magnesium oxide nanoparticles prepared by the method of manufacturing magnesium oxide nanoparticles according to the embodiment of the present invention. Referring to FIG. 5, it can be seen that nanoparticles prepared by the method of manufacturing magnesium oxide nanoparticles are magnesium oxide (MgO).

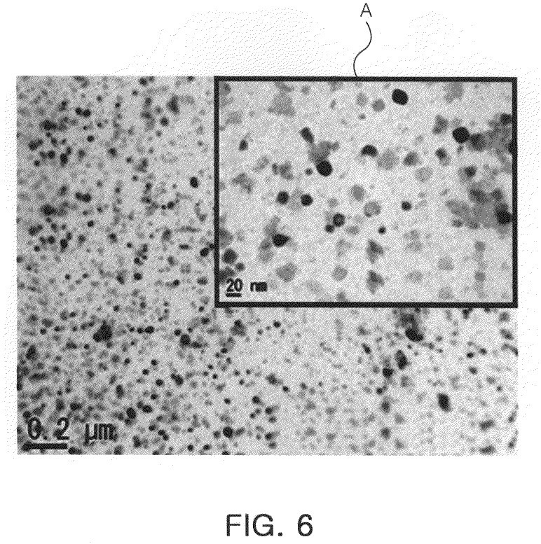

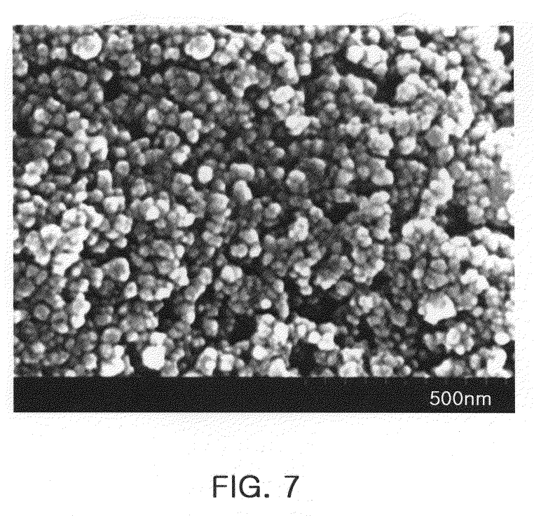

FIG. 6 is a transmission electron microscope (TEM) image of magnesium oxide nanoparticles prepared by the method of manufacturing magnesium oxide nanoparticles according to the embodiment of the present invention. FIG. 7 is a scanning electron microscope (SEM) image of the magnesium oxide nanoparticles identical to those of FIG. 6. Referring to FIGS. 6 and 7, a result of observing surfaces of the prepared magnesium oxide nanoparticles can be checked.

It can be seen from an expanded portion A in FIG. 6, that magnesium oxide nanoparticles have distinctive shapes with a size ranging from about 40 nm to about 50 nm. Also, as shown in FIG. 7, the magnesium oxide nanoparticles have relatively uniform circular shapes since aggregation of the nanoparticles does not occur. Also, the magnesium oxide nanoparticles are clearly distinguished from one another.

Hence, it is confirmed that magnesium oxide nanoparticles each of which is distinctive and having an average size of about 50 nm are manufactured by the method of manufacturing magnesium oxide nanoparticles according to the embodiment of the present invention.

According to the present invention, nanoparticles of a metal oxide such as vanadium (V), dysprosium (Dy) or yttrium (Y) can be obtained with high yield by the same method. Also, if an oxide is prepared using Mg and at least one metal material selected among V, Dy and Y by the method of manufacturing nanoparticles according to the present invention, nanoparticles of a composite metal oxide can be obtained. Like the magnesium oxide, an oxide of V, Dy or Y is used usefully as an addictive for a dielectric composition of a capacitor and in other various fields.

As described so far, according to the present invention, magnesium oxide particles having a size of tens of nanometers can be effectively manufactured by using a low-priced precursor.

Also, uniform magnesium oxide nanoparticles with desired shapes can be manufactured by controlling the shapes of the magnesium oxide nanoparticles of tens of nanometers. Also, the magnesium oxide nanoparticles can be obtained using a simple process.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing magnesium oxide nanoparticles, the method comprising:
preparing a magnesium salt solution by dissolving a magnesium salt in a solvent;
impregnating an organic polymer comprising a nanosized pore with the magnesium salt solution; and
heating the organic polymer impregnated with the magnesium salt solution until the organic polymer is fired.

2. The method of claim 1, wherein the magnesium salt solution is a magnesium nitrate (Mg(NO₃)₂) solution.

3. The method of claim 1, wherein the magnesium salt solution has a concentration ranging from 5 wt % to 15 wt %.

4. The method of claim 1, wherein the heating the organic polymer is performed at a temperature ranging from 600° C. to 700° C.

5. The method of claim 1, wherein the heating the organic polymer is performed for 30 minutes to 5 hours.

6. The method of claim 1, wherein the heating the organic polymer is performed at a heating rate of 2° C./h to 20° C./h.

7. The method of claim 1, wherein the pore of the organic polymer has a size ranging from 1 nm to 9 nm.

8. The method of claim 1, wherein the magnesium oxide nanoparticles have a size ranging from 30 nm to 60 nm.

9. The method of claim 1, further comprising drying the organic polymer impregnated with the magnesium salt solution before the heating the organic polymer.

10. The method of claim 1, further comprising milling a heating residue after the heating the organic polymer.

11. A method of manufacturing a magnesium oxide nanosol, the method comprising:
preparing a magnesium salt solution by dissolving a magnesium salt in a solvent;
impregnating an organic polymer comprising a nanosized pore with the magnesium salt solution;
heating the organic polymer impregnated with the magnesium salt solution until the organic polymer is fired;
milling a heating residue; and
dispersing the milled heating residue in an organic solvent.

12. The method of claim 11, wherein the organic solvent is ethanol.
